(19) United States
(12) Patent Application Publication
(10) Pub. No.: US 2013/0107255 A1
(43) Pub. Date: May 2, 2013

(54) SPECTROPHOTOMETER

(71) Applicants: Shigeru Matsui, Hitachinaka (JP); Daisuke Kurimoto, Hitachinaka (JP)

(72) Inventors: Shigeru Matsui, Hitachinaka (JP); Daisuke Kurimoto, Hitachinaka (JP)

(21) Appl. No.: 13/702,684

(22) PCT Filed: May 31, 2011
(86) PCT No.: PCT/JP2011/062511

§ 371 Date: Dec. 28, 2012

(30) Foreign Application Priority Data
Jun. 9, 2010 (JP) 2010-132053

(51) Int. Cl. G01J 3/10

(52) U.S. Cl. CPC G01J 3/10
USPC 356/319

(57) ABSTRACT

Disclosed is a spectrophotometer capable of achieving a good signal-to-noise ratio by improving the use efficiency of the amount of light emitted from a Xe flash lamp or other intermittent light source. Light having a desired wavelength is selected from the light emitted from the Xe flash lamp (1), which is a single light source having a wide wavelength range, allowed to pass through a sample (7), detected by a photodetector (21, 22), and supplied to a low-pass filter (24) in a signal processing circuit (23). The duration of the waveform of a signal output from the photodetector (21, 22) is extended by the low-pass filter (24), which has a time constant equivalent to the elapsed time required for the intensity of the light emitted from the Xe flash lamp (1) to decrease from a peak value to a half value and acts as delay means or other duration extension means. The signal having a waveform whose duration is extended is supplied to a computer (30) through an amplifier (25) and an analog-to-digital conversion circuit (26). As the signal having the waveform whose duration is extended can be used, it is possible to enhance the use efficiency of the total amount of emitted light and optimize the effect of signal-to-noise ratio improvement.

### TECHNICAL FIELD

The present invention relates to a spectrophotometer that measures the transmittance, reflectance, and other spectrophotometric properties of a sample within a predetermined wavelength range or at a specific wavelength.

### BACKGROUND ART

An ultraviolet-visible spectrophotometer, which measures the absorption spectrum of a sample in an ultraviolet-visible region, is available as a spectrophotometer for measuring the transmittance, reflectance, and other spectrophotometric properties of the sample within a predetermined wavelength range or at a specific wavelength. A typical ultraviolet-visible spectrophotometer is described, for instance, in Patent Document 1.

These spectrophotometers incorporate two different light sources (a deuterium discharge tube for an ultraviolet region and a halogen lamp for a visible region) and selectively use these light sources in accordance with the wavelength region to be measured. However, a volumetric capacity for incorporating the two different light sources and a complicated switching mechanism for controlling the light sources are required for the spectrophotometers. These factors inevitably increase the size and cost of the spectrophotometers.

While efforts have been made to develop a small-size, low-cost spectrophotometer in view of the above circumstances, a spectrophotometer described, for instance, in Patent Document 2 uses a single light source to cover a wide wavelength range, namely, an ultraviolet to visible region or an ultraviolet to near-infrared region, and does not require a mechanism for switching between a plurality of light sources. Such a light source is represented, for example, by a Xe (xenon) flash lamp.

The Xe flash lamp generates a substantially continuous emission spectrum in an ultraviolet to near-infrared region. Therefore, a single light source formed by the Xe flash lamp can cover a wavelength region required for ultraviolet-visible spectrometry. Further, the Xe flash lamp generates a smaller amount of heat than a common halogen lamp. Hence, the Xe flash lamp serves as a favorable light source for reducing the size of a spectrophotometer.

Meanwhile, the temporal-luminous characteristics of the Xe flash lamp are different from those of a deuterium discharge tube or a halogen lamp, which both emit light continuously in terms of time. More specifically, the Xe flash lamp emits short-duration pulsed light repeatedly and intermittently after a relatively long period of no light emission. A peak value indicative of the amount of light emitted from the Xe flash lamp during a period of pulsed light emission is greater than those of the deuterium discharge tube and halogen lamp. However, the average amount of light emitted from the Xe flash lamp per unit time, which is determined by averaging the amounts of a plurality of light emissions, is smaller than those of the deuterium discharge tube and halogen lamp.

Hence, if only light sources are merely replaced by the Xe flash lamp in a situation where the employed spectrophotometer incorporates both the deuterium discharge tube and halogen lamp as the light sources, it is difficult to maintain a signal-to-noise ratio that is achieved during conventional spectrometry.

In view of the temporal-luminous characteristics of a light source that intermittently emits light as described above, Patent Document 2 describes a technology for improving the signal-to-noise ratio by acquiring an output signal of a photodetector only during an effective light emission period of the light source and by rejecting the output signal of the photodetector during a period of no light emission.

### PRIOR ART LITERATURE

### Patent Documents

Patent Document 1: JP-1986-53527-A
Patent Document 2: U.S. Pat. No. 3,810,696

### SUMMARY OF THE INVENTION

### Problems to be Solved by the Invention

The full width at half maximum of a pulsed light emission peak of a Xe flash lamp having typical temporal-luminous characteristics is approximately 500 ns. In general, the pulsed light emission repeatedly takes place at a frequency of approximately 20 to 100 Hz. Based on the temporal-luminous characteristics and in order to acquire the output signal of the photodetector only during an effective light emission period equivalent to the full width at half maximum of the pulsed light emission peak as described in Patent Document 2, a signal processing circuit needs to have a bandwidth of a frequency response of approximately 10 MHz.

However, when the band of the signal processing circuit is widened as implied above, problems occur to degrade noise immunity or complicate the acquisition of a great gain during signal amplification. Further, when an integration circuit having a reset circuit is used, an unnecessary inflow current from a reset switch is likely to exert an adverse effect. This causes a problem such as noise generation due to high-speed switching.

The temporal-luminous waveform of the Xe flash lamp is generally asymmetric with respect to peak time, and a period during which the amount of emitted light is reduced to zero after a peak is longer than a period during which the amount of light is increased from zero before the peak. If only the amount of light emitted during a period of time equivalent to the full width at half maximum around the peak of the aforementioned temporal-luminous waveform is used, the use efficiency with respect to the total amount of emitted light is decreased so that the effect of improving the signal-to-noise ratio cannot be optimized. Consequently, it has been difficult to sufficiently improve the signal-to-noise ratio even when the Xe flash lamp is used as a light source.

An object of the present invention is to provide a spectrophotometer and a spectroscopic measurement method that make it possible to improve the use efficiency of the amount of light emitted from an intermittent light source represented by a Xe flash lamp and achieve a good signal-to-noise ratio.

### Means for Solving the Problems

The present invention is configured as described below to achieve the above object.

Light emitted from an intermittent light source, which intermittently emits light after a period of no light emission, is dispersed to acquire monochromatic light. The acquired monochromatic light is incident on a sample. The intensity of the monochromatic light transmitted through the sample is converted to an electrical signal. The duration of the electrical signal is extended to a duration longer than the half width of the temporal-luminous profile of a single light emission from the light source. Optical characteristics of the sample are calculated in accordance with the signal having the extended duration.

### Effects of the Invention

The present invention makes it possible to optimize the use efficiency of the amount of light emitted from an intermittent light source without degrading the noise immunity of a signal processing circuit and achieve a good signal-to-noise ratio.

### BRIEF DESCRIPTION OF THE DRAWINGS

FIG. 1 is a schematic diagram illustrating the configuration of a spectrophotometer according to a first embodiment of the present invention.

FIG. 2A is a diagram illustrating the temporal-luminous characteristics of a Xe flash lamp.

FIG. 2B is a diagram illustrating the temporal-luminous characteristics of the Xe flash lamp.

FIG. 3 is a schematic diagram illustrating the configuration of the spectrophotometer according to a second embodiment of the present invention.

FIG. 4 is a diagram illustrating a modification of the second embodiment.

FIG. 5 is a schematic diagram illustrating the configuration of the spectrophotometer according to a third embodiment of the present invention.

### MODE FOR CARRYING OUT THE INVENTION

Embodiments of the present invention will now be described with reference to the accompanying drawings.

### First Embodiment

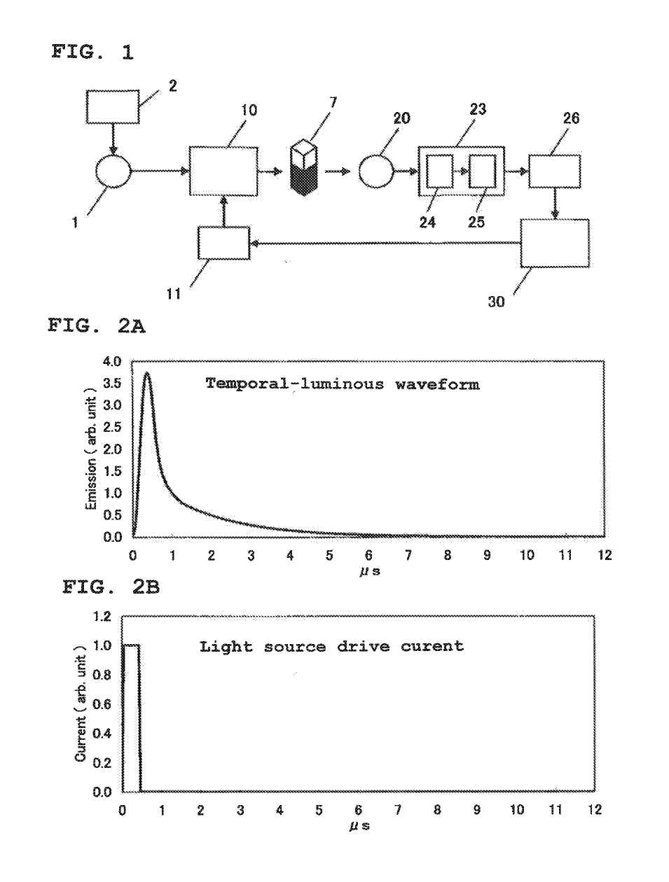

FIG. 1 is a schematic diagram illustrating the configuration of a spectrophotometer according to a first embodiment of the present invention. The first embodiment will be described in connection with a single beam spectrophotometer, which uses one beam to measure the spectrophotometric value of a sample.

Referring to FIG. 1, a Xe flash lamp is used as a light source 1. The light source 1 is driven by a light source drive current that is supplied from a light source power supply 2.

FIG. 2A is a diagram illustrating typical temporal-luminous characteristics of a Xe flash lamp. FIG. 2B is a diagram illustrating the relationship between the light source drive current from the light source power supply 2 and the temporal-luminous characteristics of the light source 1. Referring to FIGS. 2A and 2B, the full width at half maximum of a pulsed light emission peak of the light source 1 is approximately 500 ns.

Referring to FIG. 1, light emitted from the light source 1 becomes incident on a monochromator 10. A wavelength control mechanism 11, which operates on command from a computer 30, exercises control so that the monochromator 10 emits monochromatic light having a measuring wavelength of λ nm toward the sample 7. The measuring wavelength λ is selectable from a wavelength range of 200 nm to 1100 nm. A photodetector 20 converts the light transmitted through the sample 7 to an electrical signal. A silicon photodiode is used as the photodetector 20. However, a photomultiplier or a photodetector operating on a different detection principle may alternatively be used. A signal output from the photodetector 20 is directed into a signal processing circuit 23. A first stage of the signal processing circuit 23 is formed by a low-pass filter 24.

As shown in FIG. 2A, it can be regarded that the temporal-luminous profile of the Xe flash lamp attenuates in a substantially exponential fashion after a pulsed light emission has peaked and passed an inflection point. In other words, when the position of the inflection point reached after the peak of the pulsed light emission is at the origin of a temporal axis (t=0), a light signal waveform I₀(t) is expressed by Equation (1) below.

I₀(t)=e^{-k0 t} Equation (1)

In Equation (1), k is a constant derived from the characteristics of the lamp.

In order to facilitate subsequent calculations, it is assumed that the value at the inflection point of pulsed light emission is 1.

It can be regarded that a signal waveform obtained after a signal waveform of the light emitted from the Xe flash lamp, which is captured by the photodetector 20, is passed through the low-pass filter 24 substantially attenuates as indicated by Equation (2). In Equation (2), p is a proportionality constant.

I(t)=p·e^{-kt} Equation (2)

In the above instance, 0.7/k substantially corresponds to the elapsed time required before a light signal waveform I(t) is equal to half a peak value, that is, corresponds to a time constant of the low-pass filter 24. When the total amount of signal in the entire peak waveform remains unchanged, that is, when a low-pass filter whose gain is 1 is used, a result obtained by integrating Equation (1) with respect to time from t=0 to t=infinity indicates that p=k. Therefore, Equation (3) is derived from Equation (2).

I(t)=k·e^{-kt} Equation (3)

The signal-to-noise ratio prevailing in a region that is reached after a signal has passed through the low-pass filter 24, peaked, and passed the inflection point will now be evaluated.

The average instantaneous value of a noise component may be considered to be fixed without regard to the amount of light unless it is necessary to consider a shot noise due to the use of weak light. When a signal S is obtained by integrating I(t) with respect to time from t=0 to t=τ a corresponding noise N can be considered to be substantially proportional to the square root of the product of k and integration time τ because the integration time τ is longer than the time constant 1/k of the low-pass filter. Hence, Equations (4) and (5) are obtained.

S=∫₀^{τ}I(t)dt Equation (4)

N=α·(kτ)^{1/2} Equation (5)

When the signal-to-noise ratio is calculated from the above equations, Equation (6) is obtained.

Signal-to-noise ratio=(1−e^{-kτ})/{α·(kτ)^{1/2}} Equation (6)

Equation (6) is maximized when a result obtained by taking the derivative of Equation (6) with respect to τ is 0. In such an instance, Equation (7) is obtained.

2kτ+1=e^{kτ} Equation (7)

Equation (7) is satisfied when kτ is approximately 1.25. Therefore, the integration time τ for maximizing the signal-to-noise ratio is approximately 1.25/k. In this instance, Equation (6) indicates that the maximum signal-to-noise ratio is fixed without regard to the value of k as far as kτ is fixed.

In other words, when the time constant convenient for configuring the signal processing circuit is set to 0.7/k and the signal of the low-pass filter 24 is used after it is integrated for an integration time τ=1.25/k, which is appropriate for the value k, a photometric value can be constantly obtained at an optimized signal-to-noise ratio.

When, for instance, the time constant is 10 μs, the integration time should be 18 μs. However, this integration time relates to the integration of a region that is reached after a signal waveform obtained after the temporal-luminous profile of the Xe flash lamp or its signal waveform has passed through the low-pass filter 24 has peaked and passed the inflection point. An actual integration process needs to be initiated earlier, that is, initiated at the beginning of light emission of the Xe flash lamp. It is therefore necessary to add the elapsed time between the instant at which light emission begins and the instant at which the inflection point is reached after a peak. Therefore, when the time constant is 10 μs, the integration time is set, for example, to 25 μs.

Accordingly, in the first embodiment, the time constant of the low-pass filter 24 is set to 10 μs. In this instance, the response frequency band is not higher than 100 kHz. Such a response frequency band is favorable for assuring noise immunity and acquiring a great gain during signal amplification when compared to a signal processing circuit having a wide frequency band that is responsive to the temporal-luminous profile of the Xe flash lamp.

The low-pass filter 24 also provides signal amplification. The aforementioned integration process can be implemented by disposing an integration circuit downstream of the low-pass filter 24 in the signal processing circuit. Alternatively, however, the integration process may be implemented by amplifying the output signal of the low-pass filter 24, allowing an analog-to-digital converter to convert the amplified signal to digital data, and performing a digital addition process.

In the first embodiment, the output signal of the low-pass filter 24 is amplified by an amplifier 25 until an adequate signal voltage is obtained, then converted to digital data by an analog-to-digital converter 26, and input into the computer 30. A sampling interval at which the analog-to-digital converter 26 converts its input signal to digital data is 1 μs. At a sampling interval set to be substantially equivalent to or shorter than the time constant of the low-pass filter 24, the analog-to-digital converter 26 converts the output signal of the signal processing circuit 23 to a digital quantity on a substantially periodic basis.

The computer (optical characteristics calculation means) 30 adds up digital data sets that are generated for a period of 25 μs after the beginning of each pulsed light emission from the light source 1 and uses the result of addition to calculate spectrophotometric values of the sample 7, such as transmittance, absorbance, and other optical characteristics.

More specifically, if 25 digital data sets generated during a period of 25 μs are D0 to D24, the addition result indicated by Equation (8) below is used.

$$Ds = {\sum }_{i = 0}^{24} Di \qquad Equation ( 8 )$$

In the first embodiment, the monochromator 10 and the sample 7 are disposed so that the monochromatic light emitted from the monochromator 10 is incident on the sample 7. However, even if white light emitted from the light source 1 is initially incident on the sample 7 and then the light transmitted through the sample 7 is directed into the monochromator 10 to obtain monochromatic light, the signal-to-noise ratio is improved to the same extent as described earlier.

As described above, the first embodiment makes it possible to achieve an optimized signal-to-noise ratio, which can be expected from Equation (6), without widening the response frequency band of the signal processing circuit.

More specifically, the first embodiment uses the monochromator to select a desired wavelength from the light emitted from the Xe flash lamp 1, which is a single light source having a wide wavelength range, permits the light having the desired wavelength to pass through the sample 7, and allows the photodetector 7 to detect the light. Next, the low-pass filter 24, which has a time constant equivalent to the elapsed time required for the intensity of light emitted from the Xe flash lamp 1 to decrease from a peak value to a half value and acts as delay means or other duration extension means, extends the duration of the waveform of a signal output from the photodetector 7 so as to use the signal having a waveform whose duration is extended. This makes it possible to enhance the use efficiency of the total amount of emitted light and optimize the effect of signal-to-noise ratio improvement.

In the first embodiment, the signal processing circuit 23 may be configured so that an integration circuit and a reset circuit, which erases an electrical charge stored in the integration circuit, are disposed downstream of the low-pass filter 24.

The integration circuit integrates electrical signals that have passed through the low-pass filter 24 for a period of integration time equivalent to a period between the instant at which the light source 1 begins its single light emission within the temporal-luminous profile and the instant at which the intensity of the emitted light peaks and attenuates to a second predetermined intensity or lower. Immediately after the end of the integration time, the analog-to-digital converter 26 converts an electrical signal, which corresponds to the amount of electrical charge stored in the integration circuit, to digital data. Subsequently, the reset circuit erases the electrical charge stored in the integration circuit.

### Second Embodiment

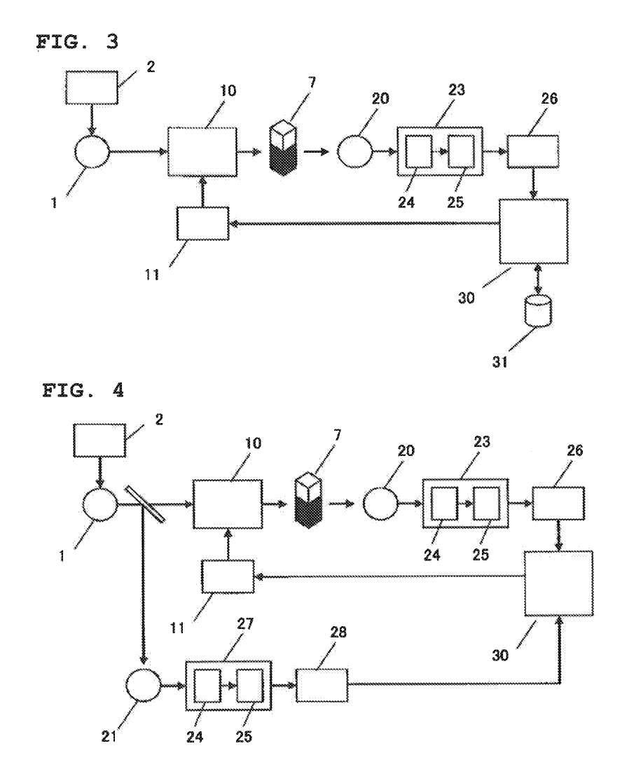

A second embodiment of the present invention will now be described. FIG. 3 is a schematic diagram illustrating the configuration of the spectrophotometer according to the second embodiment. An optical system and a signal processing system, up to and including the analog-to-digital converter 26, which are included in the spectrophotometer according to the second embodiment, are the same as those included in the spectrophotometer according to the first embodiment and will not be redundantly described.

When a photometric value is to be calculated by using a result obtained by adding up a plurality of noise-containing signals, a technology disclosed, for instance, in JP-A-2008-58239 provides an improved signal-to-noise ratio by reducing the contribution of signals having a relatively high noise level.

More specifically, the individual signals are multiplied by a weighting factor before being added up while the weighting factor is varied in accordance with the relative noise level of each signal. When the signals to be added up are statistically equal in the expected amount of noise contained in the signals, a signal having a relatively high noise level is a signal whose effective signal component is small.

The output signal of the low-pass filter 24 has a waveform that changes with time as shown in FIG. 2A. Therefore, a weighting factor sequence having a sequence of values similar to intensity changes that are evident in the waveform during the integration time is considered to be {Ci} (i=0 to 24). Each i corresponds to the sampling interval of the analog-to-digital converter 26. The weighting factor sequence {Ci} to be used is standardized to provide a maximum value of 1. In the second embodiment, Equation (9) below is used in place of an integrated value calculated from Equation (8), which is used in connection with the first embodiment.

$${D}^{′} s = {\sum }_{i = 0}^{24} ( Ci \cdot Di ) \qquad Equation ( 9 )$$

When the Xe flash lamp light source 1, the light source power supply 2 and its control conditions, and the low-pass filter 24 remain unchanged, the weighting factor sequence {Ci} has substantially the same shape each time the light is emitted. In the second embodiment, therefore, a digitized version of the weighting factor sequence {Ci} is stored in an external memory for the computer 30 as a weighting factor table 31.

The second embodiment may be modified so that the weighting factor sequence {Ci} is actually measured for acquisition purposes each time a pulsed light emission occurs. An exemplary configuration for such a modification is shown in FIG. 4.

Referring to FIG. 4, a beam splitter 12 is disposed immediately after the light source 1 so that part of the light emitted from the light source 1 is introduced into a second photodetector 21. The second photodetector 21 is equivalent to the first photodetector 20. A signal output from the second photodetector 21 is introduced into a second analog-to-digital converter 28 through a second signal processing circuit 27.

The second signal processing circuit 27 and the second analog-to-digital converter 28 are equivalent to the first signal processing circuit 23 and the first analog-to-digital converter 26, respectively. Digital data output from the second analog-to-digital converter 28 is input into the computer 30 to generate the weighting factor {Ci}. The other components of the second embodiment are the same as those of the first embodiment.

The second embodiment makes it possible to provide a better signal-to-noise ratio than the first embodiment no matter whether the scheme depicted in FIG. 3 or FIG. 4 is used.

### Third Embodiment

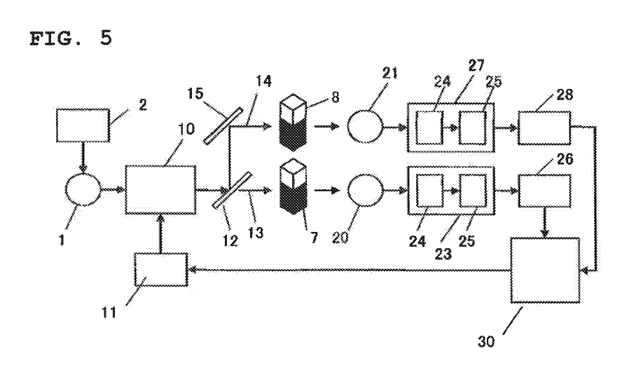

A third embodiment of the present invention will now be described. FIG. 5 is a schematic diagram illustrating the configuration of the spectrophotometer according to the third embodiment.

The spectrophotometer used in the first and second embodiments is of a single beam type, which uses one beam to measure the spectrophotometric value of a sample.

On the other hand, the spectrophotometer used in the third embodiment is of a double beam type, which uses two beams, one for a sample side and the other for a reference side. The third embodiment relates to a case where the signal processing in the first or second embodiment is applied to a double-beam spectrophotometer.

A certain portion of the optical system used in the third embodiment, namely, the light source 1 to the monochromator 10, are the same as those used in the first embodiment and will not be redundantly described.

Referring to FIG. 5, monochromatic light having a wavelength of λ is emitted from the monochromator 10 and divided into two beams by the beam splitter 12. One beam is incident on the sample 7 as a sample beam 13. The first photodetector 20, the first signal processing circuit 23, and the first analog-to-digital converter 24, which are disposed downstream of the sample 7, are the same as those used in the first embodiment and will not be redundantly described.

The other beam derived from the beam splitter 12 is reflected by a plane mirror 15 and then incident on a reference sample 8 as a reference beam 14. The light transmitted through the reference sample 8 is converted to an electrical signal by the second photodetector 21. The second photodetector 21 is equivalent to the first photodetector. A signal output from the second photodetector 21 is introduced into the second analog-to-digital converter 28 through the second signal processing circuit 27. The second signal processing circuit 27 and the second analog-to-digital converter 28 are equivalent to the first signal processing circuit 23 and the first analog-to-digital converter 26, respectively.

Digital data output from the first analog-to-digital converter 26 and digital data output from the second analog-to-digital converter 28 are both input into the computer 30. The computer 30 then adds up the input digital data in accordance with Equation (8) or Equation (9) to calculate the spectrophotometric value of the sample 7 with reference to the reference sample 8.

Consequently, even when a double-beam spectrophotometer is used in the above-described configuration, the signal-to-noise ratio can be improved, as is the case with the first or second embodiment.

Although a Xe flash lamp is used as the light source in the above examples, the present invention is applicable to a case where a pulsed laser or a laser diode is used as the light source in place of the Xe flash lamp.

### DESCRIPTION OF REFERENCE NUMERALS

1 . . . Light source
2 . . . Light source power supply
7 . . . Sample
8 . . . Reference sample
10 . . . Monochromator
11 . . . Wavelength control mechanism
12 . . . Beam splitter
13 . . . Sample beam
14 . . . Reference beam
15 . . . Plane mirror
20, 21 . . . Photodetector
23, 27 . . . Signal processing circuit
24 . . . Low-pass filter
25 . . . Amplifier
26, 28 . . . Analog-to-digital converter
30 . . . Computer
31 . . . Weighting factor table

1. A spectrophotometer comprising:
a light source (1) for intermittently emitting light after a period of no light emission;
a monochromator (10) for acquiring monochromatic light by dispersing the light emitted from the light source (1);
a first photodetector (20) for converting the intensity of the monochromatic light to an electrical signal, the monochromatic light being derived from the monochromator (10), incident on a sample, and transmitted through the sample;
first signal processing means (23) having duration extension means (24), the duration extension means having a time constant longer than the half width of the temporal-luminous profile of a single light emission from the light source (1), the duration extension means for extending the duration of a signal output from the photodetector (20); and
optical characteristics calculation means (30) for calculating the optical characteristics of the sample in accordance with a signal output from the signal processing means (23).

2. The spectrophotometer according to claim 1, wherein the duration extension means (24) is a low-pass filter; and wherein the signal processing means (23) includes an amplifier (25) for amplifying a signal output from the low-pass filter.

3. The spectrophotometer according to claim 2, further comprising:
a first analog-to-digital converter (26) for converting the signal amplified by the amplifier (25) in the signal processing means (23) to digital data;
wherein the optical characteristics calculation means (30) calculates the optical characteristics of the sample in accordance with the signal converted to the digital data by the first analog-to-digital converter (26).

4. The spectrophotometer according to claim 3, wherein the time constant of the low-pass filter (24) is a value corresponding to the duration of time between the instant at which the light source begins a single light emission within a temporal-luminous profile and the instant at which the intensity of emitted light peaks and attenuates to a first predetermined intensity or lower.

5. The spectrophotometer according to claim 3, wherein the analog-to-digital converter (26) converts the signal output from the signal processing means (23) to a digital quantity on a substantially periodic basis at a sampling interval set to be substantially equivalent to or shorter than the time constant of the low-pass filter (24).

6. The spectrophotometer according to claim 5, wherein the optical characteristics calculation means (30) calculates the optical characteristics of the sample by using a series of digital data sets acquired during a sampling time that is included in a period of time between the instant at which the light source (1) begins a single light emission within a temporal-luminous profile and the instant at which the intensity of emitted light peaks and attenuates to a second predetermined intensity or lower.

7. The spectrophotometer according to claim 6, wherein, when calculating the optical characteristics of the sample from the series of digital data sets, the optical characteristics calculation means (30) multiples each digital data set by a predetermined weighting factor so that the contribution of digital data to photometric value calculation increases with an increase in the signal intensity of the digital data.

8. The spectrophotometer according to claim 7, wherein the weighting factor applied to each data set in the series of digital data sets is determined in proportion to the intensity of emitted light corresponding to time corresponding to the sampling time for each data set within a temporal-luminous profile of a single light emission from the light source.

9. The spectrophotometer according to claim 3, wherein the signal processing means (23) includes an integration circuit and a reset circuit for erasing an electrical charge stored in the integration circuit, the integration circuit and the reset circuit being disposed downstream of the low-pass filter (24); wherein the integration circuit integrates an electrical signal that has passed through the low-pass filter (24) during an integration time equivalent to a period between the instant at which the light source begins a single light emission within the temporal-luminous profile and the instant at which the intensity of emitted light peaks and attenuates to a second predetermined intensity or lower; wherein the analog-to-digital converter (26) converts an electrical signal corresponding to the amount of electrical charge stored in the integration circuit to digital data immediately the end of the integration time; and wherein the reset circuit erases the electrical charge stored in the integration circuit after the conversion performed by the analog-to-digital converter (26).

10. The spectrophotometer according to claim 3, further comprising:
a second photodetector (21) to which a second beam is supplied directly or after passage through a reference sample, the second beam being acquired by separating part of monochromatic light emitted from the monochromator (10);
a second signal processing circuit (27) for processing a signal output from the second photodetector (21), the second signal processing circuit (27) being substantially equivalent to the signal processing means (23); and
a second analog-to-digital converter (28) for converting a signal output from the second signal processing means (27) to digital data;
wherein the optical characteristics calculation means (30) calculates the optical characteristics of the sample in accordance with digital data derived from the first analog-to-digital converter (26) and from the second analog-to-digital converter (28).

11. The spectrophotometer according to claim 10, wherein the optical characteristics calculation means (30) calculates the optical characteristics of the sample by multiplying each data set in a series of data sets derived from the first analog-to-digital converter (26) by a weighting factor, the weighting factor being determined in proportion to the intensity of digital data derived from the second analog-to-digital converter (28) at the same time as the sampling time for the each data set.

12. The spectrophotometer according to claim 3, further comprising:
a beam splitter (12) disposed after the light source (1);
a second photodetector (21) to which a second beam is supplied, the second beam being acquired by allowing the beam splitter (12) to separate part of light emitted from the light source (1);
a second signal processing circuit (27) for processing a signal output from the second photodetector (21), the second signal processing circuit (27) being substantially equivalent to the first signal processing means (23); and
a second analog-to-digital converter (28), which is substantially equivalent to the first analog-to-digital converter (26);
wherein the optical characteristics calculation means (30) calculates the optical characteristics of the sample in accordance with digital data sets derived from the first and second analog-to-digital converters (26, 28).

13. The spectrophotometer according to claim 3, further comprising:
a beam splitter (12) disposed after the light source (1);
a second photodetector (21) to which a second beam is supplied, the second beam being acquired by allowing the beam splitter (12) to separate part of light emitted from the light source (1);
a second signal processing circuit (27) for processing a signal output from the second photodetector (21), the second signal processing circuit (27) being substantially equivalent to the first signal processing means (23); and
a second analog-to-digital converter (28), which is substantially equivalent to the first analog-to-digital converter (26);
wherein the optical characteristics calculation means (30) calculates the optical characteristics of the sample by multiplying each data set in a series of data sets derived from the first analog-to-digital converter (26) by a weighting factor, the weighting factor being determined in proportion to the intensity of digital data derived from the second analog-to-digital converter (28) at the same time as the sampling time for the each data set.

14. An optical measurement instrument having an optical system with a light source (1) for intermittently emitting light after a period of no light emission, a photodetector (20) for detecting the light emitted from the light source (1), and an optical signal processing circuit (23) for processing a signal output from the photodetector (20), the optical measurement instrument comprising:
a low-pass filter (24) having a time constant longer than the half width of the temporal-luminous profile of a single light emission from the light source (1);
wherein only a low-frequency component of the signal output from the photodetector (20) is allowed to pass through the low-pass filter (24) and supplied to the optical signal processing circuit (23).

15. The optical measurement instrument according to claim 14, further comprising:
an integration circuit that is disposed downstream of the low-pass filter (24); and
a reset circuit that is disposed downstream of the low-pass filter (24) to erase an electrical charge stored in the integration circuit;
wherein the integration circuit integrates an electrical signal that has passed through the low-pass filter during an integration time equivalent to a period between the instant at which the light source begins a single light emission within the temporal-luminous profile and the instant at which the intensity of emitted light peaks and attenuates to a predetermined intensity or lower.

16. A spectroscopic measurement method comprising the steps of:
acquiring monochromatic light by dispersing light emitted from a light source that intermittently emits the light after a period of no light emission;
allowing the monochromatic light, which is acquired from a monochromator, to become incident on a sample and converting the intensity of the monochromatic light, which is transmitted through the sample, to an electrical signal;
extending the duration of the electrical signal to a duration longer than the half width of the temporal-luminous profile of a single light emission from the light source; and
calculating the optical characteristics of the sample in accordance with the signal having the extended duration.
